(19) United States
(12) Patent Application Publication
(10) Pub. No.: US 2008/0197732 A1
(43) Pub. Date: Aug. 21, 2008

(54) ADJUSTABLE BENT HOUSING WITH SINGLE OFFSET

(76) Inventor: Nicu CIOCEANU, Edmonton (CA)

Correspondence Address: EDWARD YOO C/O BENNETT JONES, 1000 ATCO CENTRE, 10035 - 105 STREET, EDMONTON, ALBERTA, AB, T5J3T2, omitted

(21) Appl. No.: 11/675,953

(22) Filed: Feb. 16, 2007

(51) Int. Cl. H02K 5/04

(52) U.S. Cl. 310/89; 175/61; 310/82

(57) ABSTRACT

An adjustable bent housing comprises a stator connector, an adjustable housing having a first axial deviation and a first offset point and a plurality of spaced teeth, a crown which is disposed between the stator connector and the adjustable housing, and has a plurality of spaced teeth which are complementary to the adjustable housing teeth, means for rotatably engaging the crown to the stator connector and a slotted mandrel disposed within the crown and having a threaded connection to the stator connector at one end, and a threaded connection to the adjustable housing at the other end. The slotted mandrel has a second axial deviation and a second offset point The first offset point and the second offset point are aligned when the adjustable bent housing is assembled, creating a single offset point.

### FIELD OF THE INVENTION

The present invention relates to an adjustable bent housing.

### BACKGROUND

When drilling a well, it is often desired to have a borehole which deviates from the vertical or from an initial section of the well, in the case of slant drilling. Adjustable bent housings have been developed to permit such directional drilling.

Conventional adjustable bent housings use an adjustable mandrel which provides a connection to the stator housing of the drilling motor, and a box connection to the bottom end of the bearing assembly. As is well known, the drive shaft passes through the bent housing.

Adjustable bent housings provide axial deviations by machining components of the housing to create a deviation, by machining deviating threads, or by machining one end of a tubular body which deviates from the other end. By combining two tubular components with axial deviations, an adjustable housing may vary between a straight configuration, and a cumulative bent configuration, which is the sum of the two deviations. These two components are threaded together and a locking nut or adjusting nut is provided to fix the two components together with the desired deviation. This locking nut must have a left-hand thread or a thread opposite the threaded connection of the two main tubular components.

Prior art adjustable bent housings often have two offset points, which commonly results in an oversize wellbore because a true straight housing cannot be achieved.

### SUMMARY OF THE INVENTION

The invention comprises an adjustable bent housing having a single offset point. The adjustable bent housing may also comprise fewer tubular components than the prior art. In one preferred embodiment, the adjustable bent housing comprises both a single offset point and fewer tubular components. Therefore, in one aspect, the invention comprises an adjustable bent housing comprising:

(a) a stator connector having a distal end, and a proximal end adapted to engage a motor stator;

(b) an adjustable housing having a first axial deviation and a first offset point, wherein a proximal end of the adjustable housing defines a plurality of spaced teeth;

(c) a crown disposed between the stator connector and the adjustable housing, wherein a distal end of the crown defines a plurality of spaced teeth which are complementary to the adjustable housing teeth, and wherein the crown comprises a short side and a long side,

(d) means for rotatably engaging a proximal end of the crown to a distal end of the stator connector;

(e) a slotted mandrel disposed within the crown and having a threaded connection to the stator connector at one end, and a threaded connection to the adjustable housing at the other end, wherein the slotted mandrel having a second axial deviation and a second offset point; and wherein the first offset point and the second offset point are aligned when the adjustable bent housing is assembled.

In one embodiment, the adjustable bent housing consists essentially of these components, eliminating at least the adjusting nut or locking nut of prior art assemblies.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is cross-sectional view of an adjustable bent housing of the present invention.

FIG. 2 is a cross-sectional view of a stator connector.

FIG. 2A is a cross-sectional view of the engagement between a stator connector and a crown.

FIG. 3 is a cross-sectional view of a slotted mandrel.

FIG. 4 is a cross-sectional view of a crown along line IV-IV in FIG. 4A.

FIG. 4A is an axial cross-section along line IVA-IVA in FIG. 4.

FIG. 4B is an axial cross-section along line IVB-IVB in FIG. 4.

FIG. 5 is a cross-sectional view of an adjustable housing of the present invention.

### DETAILED DESCRIPTION OF PREFERRED EMBODIMENTS

The present invention relates to an adjustable bent housing. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

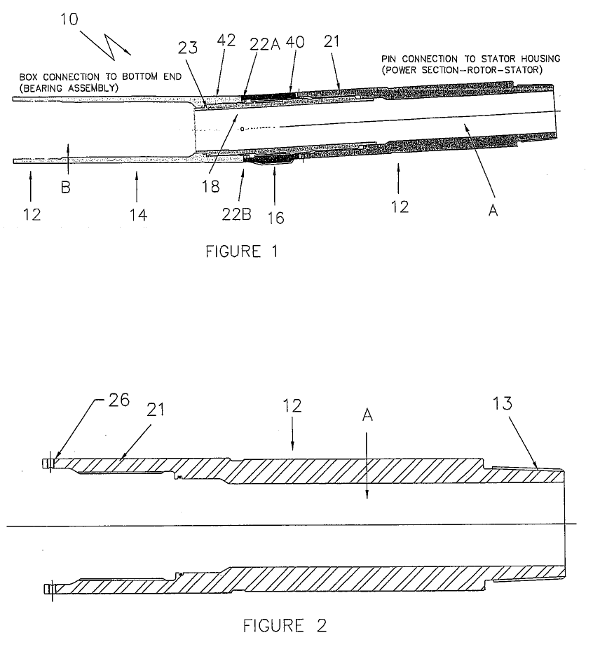

As seen in FIG. 1, an adjustable bent housing (10) of the present invention comprises a first tubular member (12), referred to herein as the stator connector, and a second tubular member (14), referred to herein as the adjustable housing. Disposed in between the stator connector (12) and the adjustable housing (14) is a third tubular member (16), referred to herein as the crown. Disposed concentrically within the stator connector (12), the crown (16) and the adjustable housing (14) is a fourth tubular member, referred to herein as the slotted mandrel (18).

The stator connector (12) connects at its proximal end (13) to the stator of a downhole motor, as is well known in the art, and defines a first longitudinal axis, shown as dashed line “A”, and the distal portion (20) of the adjustable housing (14) defines a second longitudinal axis “B”. The angle between “A” and “B” has a single offset point and may be varied by operation of the present invention.

The stator connector (12) is shown in FIG. 2. The inner bore of the stator connector (12) engages the slotted mandrel (18) by a standard threaded connection (21) as is well known in the art. A suitable seal may be provided to prevent the ingress of drilling mud. The distal end (23) of the slotted mandrel similarly engages the proximal end (22) of the adjustable housing by a standard threaded connection. Again, a suitable seal may be provided.

The stator connector (12) engages the crown (16) by means of the overlap shown in FIG. 1 and in detail in FIG. 2A. The engagement between the two permits rotational movement but links the two longitudinally. In one embodiment, the engagement means comprises a plurality of ball bearings (50) which are inserted into openings (52) in the stator connector, are retained by set screws (54), and which engage a radial groove (56) in the crown (16). In one alternative, a cycle ring may be used. Thus, the stator connector (12) may rotate independently of the crown (16), but axial movement of the stator connector results in axial movement of the crown.

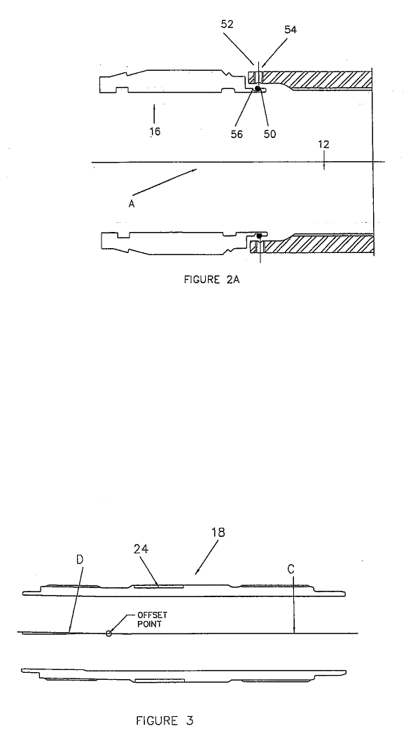

As shown in FIG. 3, the slotted mandrel (18) has two longitudinal axes, where the axis of the proximal portion (C) is aligned with the axis (A) of the stator connector and the axis of the distal portion (D) is aligned with the deviated portion of the adjustable housing. The angle between C and D may be 1.5° for example.

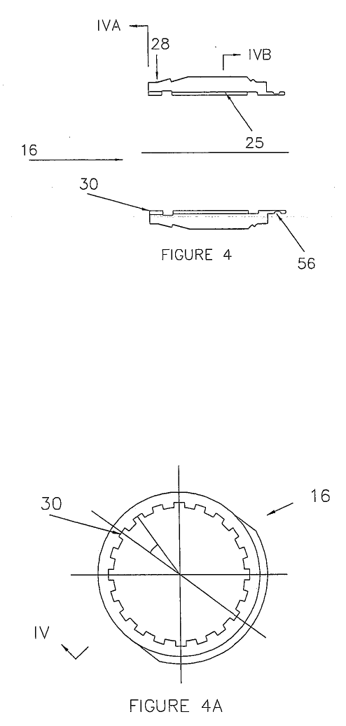

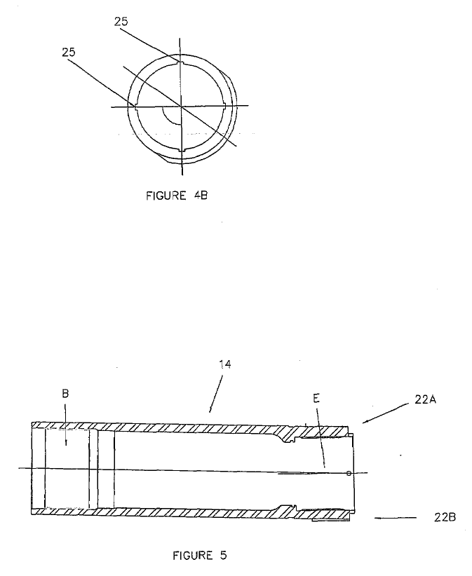

The exterior of the slotted mandrel (18) defines a number of longitudinal splines (24) which mate with grooves (25) on the interior of the crown (16), which may be seen in FIG. 4B. Thus, the slotted mandrel (18) may slide along the crown (16), but is in fixed rotational position relative to the crown. The distal end (28) of the crown (16) defines a number of spaced internal teeth (30) which mate with spaced teeth (32) machined into the adjustable housing (14).

The adjustable housing is shown in FIG. 5. The internal threads of the proximal end (22) of the adjustable housing has an axis “E” which is deviated from axis “B” and thus the proximal end has a short side (22A) and a long side (22B). The deviation from axis “B” may be 1.5° for example. The deviated axis (E) of the adjustable housing is defined by the threaded bore of the adjustable housing, which engages the distal portion of the slotted mandrel. The longitudinal axis (B) of the adjustable housing intersects with the deviated axis at the same point as it intersects with axis A of the stator connector (12).

The crown (16) also has a short side (40), shown in FIG. 1, but not FIG. 4, which is a symmetrical cross-sectional view along line IV-IV in FIG. 4A. As a result, the single offset point is positioned at about the interface between the crown (16) and the adjustable housing (14). The deviation of the adjustable housing and the deviation of the slotted mandrel are aligned when the adjustable bent housing is assembled, to create a single offset point.

Therefore, as may be appreciated by one skilled in the art, rotation of the crown (16) relative to the adjustable housing (14) allows variation in the degree of offset between the stator connector (12) and the adjustable housing (14), or in other words, between axes A and B. When the short side (40) of the crown aligns with the short side (42) of the adjustable housing, the full amount of offset is provided. Conversely, when the short side (40) of the crown is opposite of the short side (42) of the adjustable housing, the adjustable bent housing becomes straight.

In operation, the stator connector (12) is rotated to back off the stator connector (12) and the crown (16) from the adjustable housing (14). The crown (16) does not rotate because of its toothed engagement with the adjustable housing (14), and the slotted mandrel (18) also does not rotate because of its splined engagement with the crown (16). As the crown (16) moves away from the adjustable housing (14), the crown teeth (30) then disengage the adjustable housing teeth (40) and the crown may then be rotated relative to the adjustable housing to provide the desired amount of offset.

Indicators may be provided on the exterior of the crown and the adjustable housing which permits selection of degree of offset by aligning matching indicators. For example, 3° of offset is required, then the indicator for 3° on the crown is aligned with the indicator for 3° on the adjustable housing, which if the two deviations are 1.5° each, means that the short sides of the deviated components are aligned.

Once the desired adjustment is made, the stator connector is rotated to secure the assembly by reengaging the crown teeth (30) against the adjustable housing teeth (40), and stator connector may then be torqued to an appropriate torque specification.

What is claimed is:

1. An adjustable bent housing comprising:
(a) a stator connector having a distal end, and a proximal end adapted to engage a motor stator;
(b) an adjustable housing having a first axial deviation and a first offset point, wherein a proximal end of the adjustable housing defines a plurality of spaced teeth;
(c) a crown disposed between the stator connector and the adjustable housing, wherein a distal end of the crown defines a plurality of spaced teeth which are complementary to the adjustable housing teeth, and wherein the crown comprises a short side and a long side,
(d) means for rotatably engaging a proximal end of the crown to a distal end of the stator connector;
(e) a slotted mandrel disposed within the crown and having a threaded connection to the stator connector at one end, and a threaded connection to the adjustable housing at the other end, wherein the slotted mandrel has a second axial deviation and a second offset point; and wherein the first offset point and the second offset point are aligned when the adjustable bent housing is assembled.

2. The adjustable bent housing of claim 1 wherein the rotatable engagment means comprises a plurality of retention balls disposed within a groove defined by the inner surface of the stator connector and the outer surface of the crown.

3. The adjustable bent housing of claim 1 consisting essentially of:
(a) a stator connector having a distal end, and a proximal end adapted to engage a motor stator;
(b) an adjustable housing having a first axial deviation and a first offset point, wherein a proximal end of the adjustable housing defines a plurality of spaced teeth;
(c) a crown having a second axial deviation and a second offset point, the crown disposed between the stator connector and the adjustable housing, and wherein a distal end of the crown defines a plurality of spaced teeth which are complementary to the adjustable housing teeth,
(d) means for rotatably engaging a proximal end of the crown to a distal end of the stator connector;
(e) a slotted mandrel disposed within the crown and having a threaded connection to the stator connector at one end, and a threaded connection to the adjustable housing at the other end; and
wherein the first offset point and the second offset point are aligned when the adjustable bent housing is assembled.
